(19) United States
(12) Patent Application Publication
(10) Pub. No.: US 2006/0126556 A1
(43) Pub. Date: Jun. 15, 2006

(54) Territory mapping for efficient content distribution in wireless networks using broadcast/multicast

(75) Inventors: Hong Jiang, Westfield, NJ (US); Dennis W. Specht JR., Sparta, NJ (US); James A. Nelson, Fair Haven, NJ (US)

Correspondence Address: Edward A. Pennington;SWIDLER BERLIN LLP, Suite 300, 3000 K. Street, N.W., Washington, DC, 20007-5166, US

(73) Assignee: Roundbox, Inc., Bridgewater, NJ (US)

(21) Appl. No.: 11/054,361

(22) Filed: Feb. 9, 2005

Related U.S. Application Data
(60) Provisional application No. 60/635,771, filed on Dec. 14, 2004.

(51) Int. Cl. H04J 1/00; H04J 3/26; H04Q 7/00

(52) U.S. Cl. 370/328; 370/432; 370/489

(57) ABSTRACT

A technique for content delivery in wireless networks which associates a desired broadcast/multicast (BCMC) territory with the content, estimates cell sector coverage area from a subscriber location data set, and then identifies a set of cell sectors to be sent the content using a BCMC protocol. The method involves first receiving a description of a designated broadcast/multicast (BCMC) territory in terms of a physical area. Next, a content indicator associated with the BCMC territory is identified. The content indicator identifies content, such as text or image data, that is to be supplied to subscribers located in the territory. A cell sector coverage area is then estimated from a subscriber location data set wherein the data set includes at least a geographic location and a cell sector identifier for multiple subscribers. The BCMC territory description and the estimated cell sector coverage areas are then compared against the subscriber location data set to identify a set of targeted cell sectors. Finally, the content indicator is then sent to the set of targeted cell sectors using a BCMC protocol.

### CROSS REFERENCE TO RELATED APPLICATIONS

This application claims the benefit of an earlier U.S. Provisional Patent Application Ser. No. 60/625,771 filed on Dec. 10, 2004 entitled “Efficient Content Distribution in Wireless Network Using Broadcast/Multicast”, the entire contents of which are hereby incorporated by reference.

### FIELD OF THE INVENTION

The present invention relates to wireless networks and more particularly to efficient content distribution using broadcast/multicast protocols.

### BACKGROUND OF THE INVENTION

With the deployment of 3G wireless data networks comes higher available wireless bandwidth for mobile applications. Media-rich, high-content and interactive applications are expected to fill 3G pipes rapidly, providing increased subscriber revenue for mobile operators. However, despite the greater availability, wireless bandwidth is still expensive and scarce enough that usage must be carefully planned. The limited bandwidth available with 2.5G/3G wireless data networks cannot efficiently and cost effectively deliver an increasing number of one-to-many and many-to-many rich-media applications to million of subscribers.

A one-to-many application is one in which content is to be sent from one entity to many subscribers. Video on demand is a typical one-to-many application. A many-to-many application is one where content can be sent from a subscriber to many other subscribers. Push-to-talk is an example of a many-to-many application. Both one-to-many and many-to-many applications include location-based broadcast/multicast applications, Push-To-Talk (PTT), broadcast/multicast audio/video services such as TV/radio on mobile phones, event notification, and interactive multi-person games.

Today these one-to-many and many-to-many applications often support multicast at the Internet Protocol (IP) network layer. Multicast is a message addressing scheme that permits a single message to be addressed to a select group of subscribers. However, even standard IP multicast techniques use an inefficient unicast mechanism at the physical layer, or air interface between a mobile and a base station.

For example, with present day wireless networks, content is typically delivered to subscribers using an inefficient unicast scheme as shown in FIG. 1. Each individual application sends its respective content (media stream) over a dedicated wireless link to the “n” subscribers that participate. Due to this inefficiency, for example, some mobile operators set a small limit to the number of participants in a PTT group call to avoid congestion on the wireless links.

To solve this problem, new broadcast/multicast technologies are being proposed in the wireless standard bodies that optimize bandwidth efficiency in the Radio Access Networks (RANs) for one-to-many and many-to-many applications. The technologies are called BroadCast MultiCast Systems (BCMCS) in the 3GPP2 standards group, and are called Multicast Broadcast Multimedia Systems (MBMS) in 3GPP standards group. Using these technologies, broadcast/multicast content is only sent over the air once and can be received by many subscribers simultaneously as long as they belong to the same cell sector. One difference between broadcast and multicast is that any subscriber within a broadcast coverage area can receive broadcast content. On the other hand, multicast content is typically encrypted so that it can only be received by subscribers belonging to a specific multicast group having the necessary decryption key.

Both 3GPP and 3GPP2 support not only an IP multicast mechanism but also broadcast/multicast at all network layers below IP (e.g. down to the air interface layer).

At the present time there are two sets of standard protocols that provide end-to-end communications necessary for broadcast/multicast, as defined by 3GPP2 and 3GPP, respectively. (For further information, please refer to the communication standards cited [1]-[12] at the end of this document and incorporated by reference herein).

However, these protocol sets do not provide all necessary functions/features in order for a mobile operator to deliver broadcast/multicast services using an efficient business model for these particular services.

The patent literature describes certain approaches to content delivery in wireless networks. But each of these also has shortcomings. For instance, United States Patent Application 20010036224 to Demello et al. date Nov. 1, 2001, entitled “System and method for the delivery of targeted data over wireless networks”, recognizes that location-based wireless networks can provide services or information based the particular geographic location or profile of a wireless user.

In connection with a Mobile Switching Center (MSC), one or more platforms called Mobile Location Gateways (MLGs) are used to track the location of wireless users. The MLGs determine the location of wireless transceivers based on inputs from different location determination technologies such as via the analysis of signals transmitted between the telephone system and one or more sites, e.g., cell/sector, micro/pico cells, using angle of arrival, time of arrival, Global Positioning System (GPS) and other techniques. A Current Data Base (CDB) receives and stores the most recent location data transmitted from a Mediation Server as a sequence of records that indicate user location. The thus provides a snapshot view of user geographical distribution. A Targeting and Profiling Processor (TPP) then selects targeting profiles by matching content criteria. The TPP then continuously compares targeting criteria of the campaign with the run time parameters for each of the subscribers using anonymous user identifiers. The TPP 51 identifies each of the anonymous identifiers at a given point in time with conditions that trigger delivery of the targeted content.

Furthermore, it appears that content delivery decisions are made on a per user basis, in a way such that the location of each specific, albeit anonymous, user must be determined for each message.

United States Patent Application 2002/0115453 to Poulin et al. entitled “Method and System for Location Based Wireless Communication Services” describes a communication system where subscribers are provided with services based on their location relative to one of a plurality of pre-defined service areas. A subscriber is provided with information about a pre-defined service area that the subscriber is located in or proximate to. The subscriber is also provided with information about locations, events, attractions, and/or points of interest located in the service area. The pre-defined service areas are defined as “villages”, and information about locations, events, attractions, and/or points of interest located in a village service area is defined as venue information.

One or more location based wireless service centers, comprising a processing system are configured to provide map-serving, tracking, navigation, messaging and other features.

Responsive to activating the service, the processing system may automatically determine the location of a requesting device relative to one of the plurality of pre-defined service areas (villages) and generate a response message for the requesting device that causes the device to display at least one of the service area information (information on the villages), the venue information (information on events attractions within a village), and/or the subscriber information (information on other subscribers located in a village or proximate to the village).

This system thus supports the concept of defining a wireless service area as a “village” that contains “venues” with associated services. There is no discussion, however, of how the system would accept a content description in terms of a desired broadcast/multicast territory, and or otherwise more efficiently deliver that content to a set of cell sectors in a manner which is more efficient than on a per user basis.

### SUMMARY OF THE INVENTION

The present invention is a technique for content delivery which associates a desired broadcast/multicast (BCMC) territory with the content, estimates cell sector coverage area from a subscriber location data set, and then identifies a set of cell sectors to be sent the content using a BCMC protocol.

In one embodiment, the invention may be implemented as a content delivery method that involves first receiving a description of a designated broadcast/multicast (BCMC) territory in terms of an extent of a physical area. Next, a content indicator associated with the BCMC territory is identified. The content indicator identifies content, such as text, image or video data, that is to be supplied to subscribers located in the designated BCMC territory. Then, a subscriber location data set is collected wherein the data set includes at least a geographic location and a cell sector identifier for each of multiple subscribers. The location data set is processed to generate a location data set that is within the BCMC territory, referred to as the Territory Location Data Set herein.

The Territory Location Data Set is then processed to extract the corresponding cell sectors that will transmit the broadcast/multicast content to the territory, referred to as the Transmitting Cell Sector Set. Cell sector coverage area can be estimated from a subscriber location data set or by radio frequency coverage maps. In either event, the cell sector coverage areas are then used to coverage a particular broadcast/multicast territory using the minimal number of cell sectors to transmit the broadcast/multicast content. This creates the Transmitting Cell Sector Set.

Finally, the content indicator is then sent to the set of targeted cell sectors in the Transmitting Cell Sector Set.

If a subscriber is connected to any one of the cell sectors within the Transmitting Cell Sector Set, then he will receive the broadcast/multicast content signals. In other words, if a subscriber is located within the broadcast territory, then he will receive the broadcast/multicast content signals.

The method may include further optional steps. For example, the broadcast/multicast territory may be determined with reference to a set of latitude/longitude points, or in terms of a named venue such as an airport, stadium, freeway location, or other public named place designation.

The content indicator typically relates in some way to the BCMC territory. When associated with a named venue, such as an airport, sports stadium, city freeway location, for example, the content indicator can include flight schedules, sport event statistics, freeway traffic reports, or other venue-associated content.

The content indicator may also include other elements such as a content streams, or program guides that further indicate parameters of content streams and their BSMC channel, time, and availability information.

The cell sector coverage area can be determinen in other ways, such as from available radio coverage maps or other data provided by a wireless carrier.

The invention also accommodates changes in the BCMC environment. For example, the invention can further take steps to determine when events occur that result in changes to the subscriber location data set, when a cell sector is malfunctioning, or the like.

### BRIEF DESCRIPTION OF THE DRAWINGS

FIG. 1 illustrates the prior art, including a unicast message delivery technique and the advantage that broadcast/multicast messaging can provide.

FIG. 2 illustrates various Local Broadcast/Multicast Applications that can be implemented with the invention.

FIG. 3 illustrates the architecture of one implementation of the invention, the Roundbox Broadcast/Multicast Platform.

FIG. 4 illustrates a Roundbox platform as deployed in a 3GPP2 network.

FIG. 5 illustrates a Roundbox platform as deployed in a 3GPP network.

FIG. 6 is an example base station coverage map.

FIG. 7 is a high level diagram of the elements of a territory mapping service provided by the invention.

FIG. 8 is a flow diagram of the steps performed by a territory mapping process to determine a Transmission Cell Sector Set.

FIG. 9 illustrates how a territory may be specified in terms of multiple shapes.

FIG. 10 is a graphic depiction of a typical mobile location data set.

FIG. 11 is a flow diagram of one method for distributing content once the Transmission Cell Sector Set is known.

FIG. 12 is a flow diagram of another such method.

FIG. 13 illustrates one possible interface between the subscriber management function and other databases.

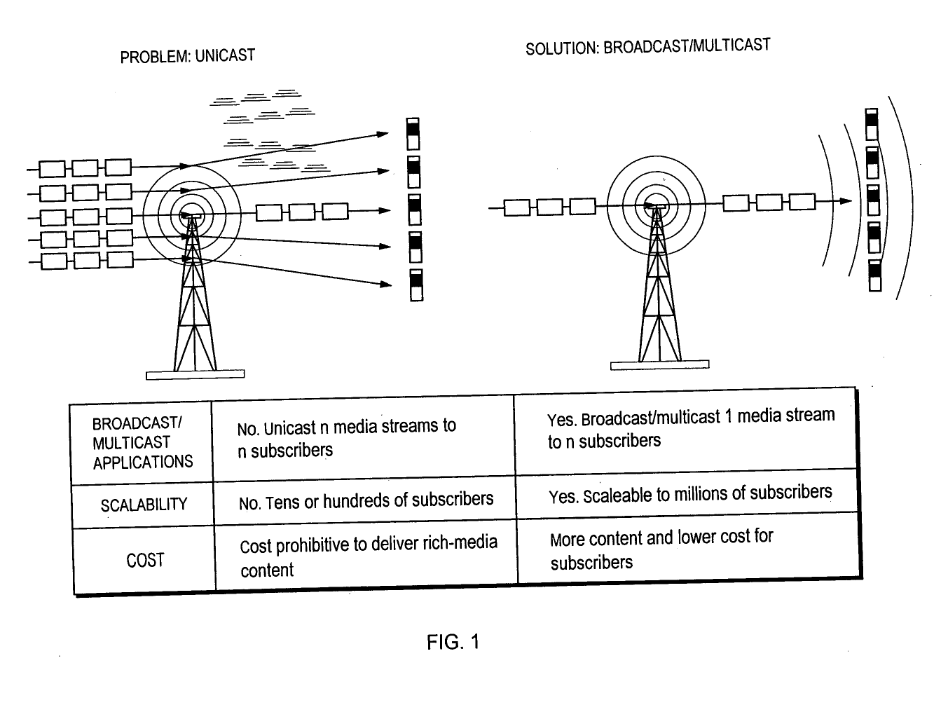

### DESCRIPTION OF A PREFERRED EMBODIMENT

1.0 Introduction

The present invention is a Broadcast/Multicast Platform, called the “Roundbox platform” herein. The platform may use various underlying technologies to deliver broadcast/multicast content in wireless networks. For example, in a 3GPP2 network, the platform may use the BroadCast/MultiCast Systems (BCMCS) protocol. Or, in a 3GPP network, a Multicast Broadcast Multimedia System (MBMS) protocol may be used. Detailed specifications for such protocols are not pertinent to the present invention, but can be found in the specification documents referenced at the end of this section.

The Roundbox platform can also be used with other broadcast/multicast networks as long as the service layer of these broadcast/multicast networks are similar to each other. These potential broadcast/multicast networks include at least Digital Video Broadcast-Handheld (DVB-H) and a proprietary scheme supported by Qualcomm, Inc. using its so-called Forward Link Only (FLO) Mediacast technology.

Regardless of the type of broadcast/multicast network model used for delivery, the Roundbox platform provides operators scalability, efficiency and completeness to deploy broadcast/multicast applications at a fraction of what the cost would be otherwise. The platform supports a wide variety of one-to-many and many-to-many broadcast/multicast services/applications. These services/applications include local broadcasting with location specific content (e.g., weather, traffic, event calendar), event notification, interactive TV/radio, push-to-talk (PTT), conference calls, and multi-person mobile games.

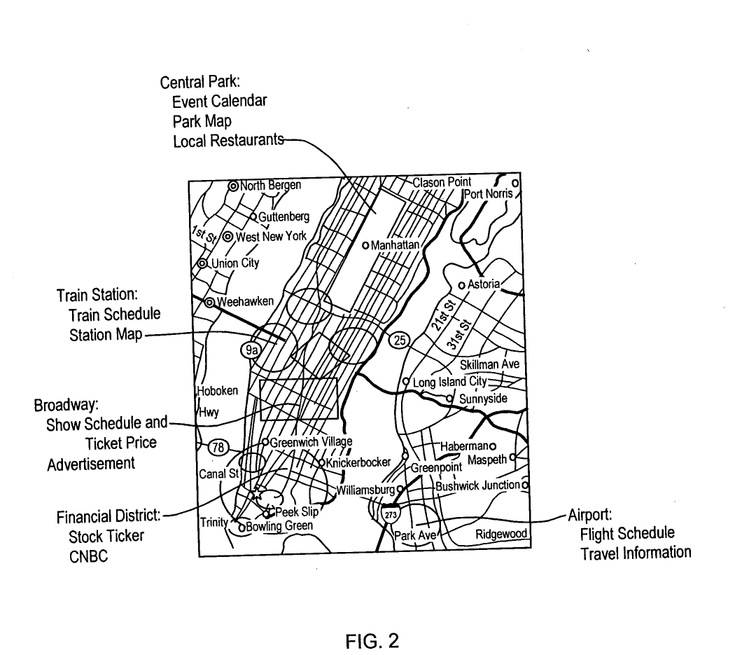

By way of brief reference now to FIG. 2, the Roundbox platform allows a mobile subscriber to receive different broadcast/multicast information depending on his location. Some of the services are free broadcast information (e.g., train schedule, advertisement), while other services (e.g., news such as “CNBC” and “Stock Ticker”) may be subscription based. As far as the user interface goes, the various services can be accessed via buttons or menus on the subscriber's device that allow access to a programming guide. The guide may then specify content by channel number, e.g., channel 1 (“Train schedule”), channel 2 (“Event Calendar”), channel 3 (local restaurants), channel 4 (music videos), etc. The subscriber can then surf various channels similar to watching television or listening to a radio.

The benefits to mobile operators include:
Creation of new broadcast/multicast applications such as local broadcast apps with location specific content targeting a specific geographic location (e.g., airport, amusement park, shopping areas).
Scalability to support millions of users for the existing one-to-many and many-to-many applications through the use of broadcast/multicast technologies. Such applications include Push-to-Talk, video/audio streaming.
Lower network cost due to higher bandwidth efficiency over the airlink, and on the core and backhaul networks.

The benefits to subscribers include
Availability of much more media-rich content
Access to broadcast/multicast channels similar to tuning to TV channels for news, traffic, entertainment and location-specific information.
Highly economical due to bandwidth sharing
Broadcast/multicast applications are not intrusive

1.1 Platform Architecture

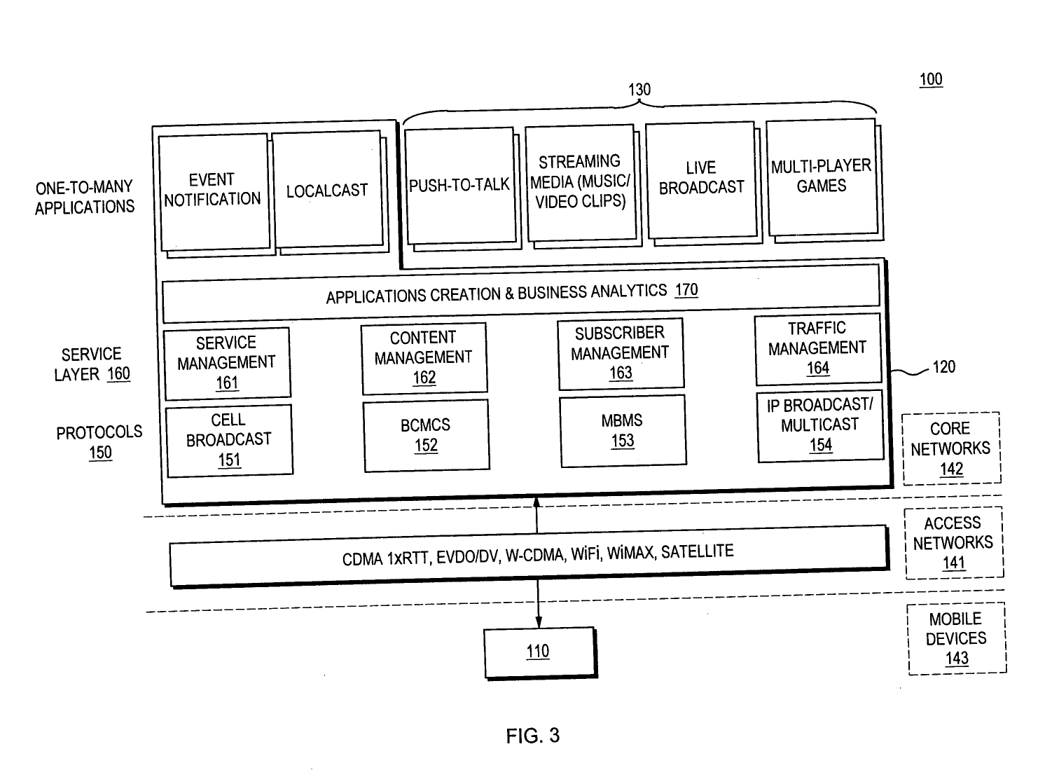

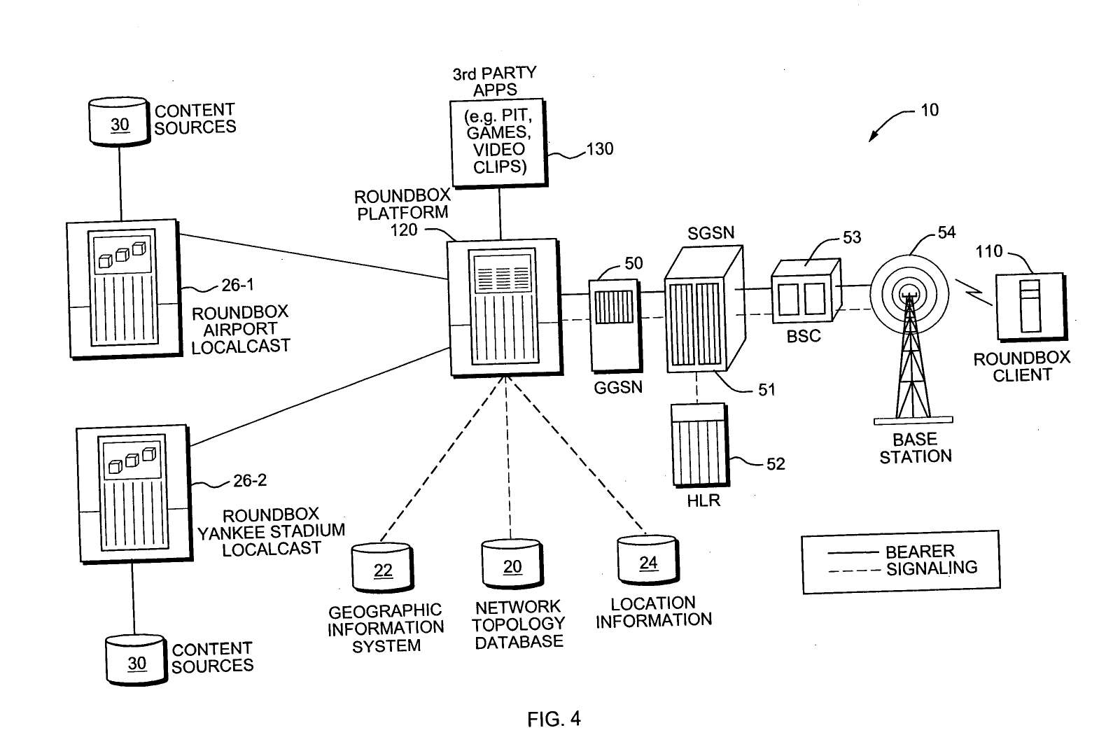

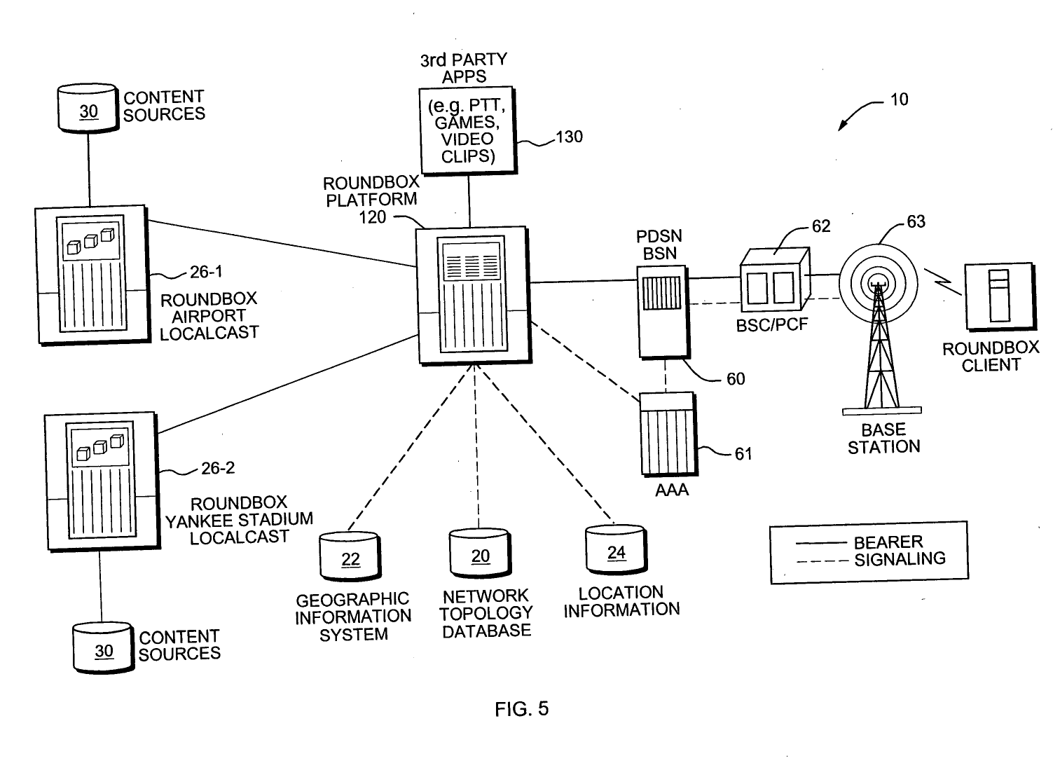

The Roundbox service platform enables a mobile operator to manage and scale broadcast/multicast services and also manage subscribers and content providers. FIG. 3 is a high level architecture of the Roundbox system platform. FIG. 4 and FIG. 5 illustrate how the Roundbox system platform fits into existing 3GPP2 and 3GPP network architectures. Typically the Roundbox Platform 120 resides in a mobile operator's core network 10. However, the Platform 120 can reside in a third-party hosted environment if the mobile operator opts for hosted services. The Platform 120 maintains the overall services and business view of the broadcast/multicast services, policies, and business models.

FIG. 4 illustrates an example of how the Platform 120 is integrated into a 3GPP2 network 10, with supporting bearer and signaling links to a Gateway GPRS Support Node (GGSN) 50, Serving GRPS Support Node (SGSN) 51, Home Location Register (HLR) 52, Base Station Controller (BSC) 53, and Base Station 54.

The Platform 120 maintains and/or has access to a Network Topology Database 20, a Geographic Information System 22, and Location Information databases in order to support several features as more fully explained below (e.g., broadcast/multicast territory mapping, location-based content delivery, and the like). The Platform 120 provides LocalCast services from one more content sources 30 to a Roundbox client 110 associated with a mobile subscriber device. For example, a first LocalCast 26-1 might provide airport information, and a second LocalCast 26-2 might provide information relating to Yankee Stadium in New York City.

FIG. 5 is a similar high level view of the Platform 120, and how it integrates into a 3GPP network with supporting bearer and signaling links to and from a Packet Data Serving Node (PDSN)/Broadcast Serving Node (BSN) 60, Authentication, Authorization and Accounting (AAA) 61, Packet Control Function (PCF)/Base Station Controller (BSC) 62, and Base Station 63.

1.2 Broadcast/Multicast Platform

As shown in FIG. 3, the Roundbox system 100 consists of three major components: a mobile device client 110, the Broadcast/Multicast platform 120 and applications 130. The mobile device 110 client is a Qualcomm BREW or J2ME based client. Typically the broadcast/multicast platform 120 resides in a mobile operator's core network. However, the platform 120 can also reside in a third-party hosted environment if the mobile operator opens up its network. The applications 130 can reside in or outside a mobile operator's networks 141, 142.

The Roundbox broadcast/multicast platform 120 consists of three main layers.

1.2.1 Protocol Layer 150
The bottom layer is the protocol layer 150 that includes (but not limited to) four protocols as defined by the respective communication standards in use: Cell Broadcast 151, BCMCS's controller and content server 152, MBMS's MB-SC 153 and IP broadcast/multicast 154. It can be easily envisioned that other protocols such as SS7, WAP and SIP may be added to the protocol layer 150. Some of the protocols in this layer are network dependent. For example, BCMCS 152 is specific to 3GPP2 networks, while MBMS 153 and Cell Broadcast 151 are specific to 3GPP networks.

1.2.2 Service Layer 160
Above the protocol layer 150 is a service layer 160. The service layer 160 is a proprietary layer that provides management capabilities as needed to implement the desired broadcast/multicast services. The service layer 160 takes many factors into consideration in providing service management. Such factors include mobile operators' business models (revenue and profit), value chain (e.g., content providers), network operations, subscriber management, pricing plans, network/operator constraints, subscriber preferences and devices. For simplicity, these capabilities are broken into four major categories: Service Management 161, Content Management 162, Subscriber Management 163 and Traffic Management 164.

1.2.2.1 Service Management 161
Service Management includes the following capabilities:
   1. Authentication and policy-based access control set by the mobile operator, the subscriber and the content providers, respectively.
   2. Support of content-provider paid and subscriber paid charging models. Within the subscriber paid charging model, flat-rate subscription and pay per view pricing plans are supported.
   3. Support of live and non-real-time broadcasting/multicasting (the “TiVo” feature). In the case of non-real-time services, content can be broadcast/multicast with a delay of a specific amount of time or it can be scheduled in off-peak hours (e.g., midnight). Alternatively, idle cycle broadcasting/multicasting of content during the peak hours is also supported.
      Mobile devices need to have certain storage space in order for this feature to work. For instance, some higher end subscriber devices phones can store one hour of video or more. In addition, there can be a software client on the subscriber device that allows for search and selection of programs, and the setting of recording schedule(s).
      The Roundbox mobile client 110 can also be used to collect usage statistics to measure network utilization and detect peak and non-peak hours. It will schedule non-real-time broadcasts/multicasts content during off peak hours. The handset stores the content. The handset client can replay, rewind and fast forward the content.
      For idle cycle broadcast/multicast during peak hours, the Roundbox platform 120 can also require more accurate and finer measurements of network utilization within the broadcast/multicast territory. For instance, instead of a measurement every 10 minutes in the off peak hours, it may require a measurement every 1 minute. Using mathematical modeling, the Roundbox platform 120 can predict the probability distribution of network utilization level in the next minute. Based on the probability distribution, the platform 120 makes an optimized decision on how much content to broadcast/multicast. The optimization goal is to push out as much content in the background as possible with minimal interference to the existing network traffic. This broadcast/multicast can be closer to real-time than the off-peak non-real-time broadcast/multicast. The delay may be only a few minutes.

4. Program Schedule
Broadcast/multicast applications are scheduled to target specific geographic locations.
   In a real live network, it can be envisioned that there could be thousands of channels broadcasting/multicasting simultaneously to hundreds of locations and perhaps a million subscribers tune into these channels at a single point in time. To schedule a program means defining the following parameters: content description, broadcast/multicast territories, time, data rate, required QoS, etc. The schedule itself is described in these parameters. The scheduling considerations include the following:
      Mobile operator's service level agreement with the content providers: for instance, a mobile operator may be limited in its contract in which markets and what time of the day the content can be delivered.
      Mobile operator's service level agreement with its enterprise customers: for instance, Newark Airport pays for Verizon to broadcast flight schedules free to subscribers. The contract may include the broadcast/multicast territory, the bandwidth of each channel, etc.
      Service level of the channel: premium channel is given high scheduling priority
      Application level QoS requirement: delay, delay jitter, error rate
      The network resources available and the network resources required for a particular program
      Revenue/profit consideration: Given that two channels require the same amount bandwidth and QoS, the channel with the higher content value potentially should be given high scheduling priority. Alternatively, if the two channels bring in the same amount of revenue, then the channel that requires less bandwidth/QoS may be given the priority.
      The popularity of the channel: A popular channel with the most viewers is given the scheduling priority. The Roundbox platform keeps track of the statistics of the number of viewers of a particular channel/program. This function is performed as described in more detail below in Section 1.2.3 Business Analytics.

5. Program Announcement
Announcement of broadcast/multicast applications to the targeted subscriber groups using the user/content provider preferred announcement delivery methods. Once the program schedule is determined, a program guide is created. The program guide can be delivered to the target audience using several methods: Cellcast as defined by 3GPP, email, SMS, MMS, WAP and website.

6. Program Management
Monitoring and control of applications that are on the air: initiate, terminate and pause and resume a program

7. Mobile transaction portal originated from broadcast/multicast content.
When broadcast/multicast content is displayed on the mobile devices, a telephone number, URL or a tag can be imbedded in the content to facilitate mobile commerce.

8. Support of multicast program preview
For multicast services, if a mobile user has not subscribed to a particular service, he is not able to decrypt and view the content. To entice the users to subscribe, preview capability without subscription is supported so that the mobile user can preview the content for a predetermined amount of time (e.g., 60 seconds). The subscriber not only gets a sense of what content is played but also the quality of reception. The later is especially important because typically there is no uplink feedback to the network indicating the quality of reception. This way, if the subscriber can decide the quality is not good, he does not need to subscribe. Preview can be broadcast for free to subscriber for a pre specified amount of time (e.g., 2 minutes) ahead of the scheduled broadcast time. There could be a trailer of all programs to come. No encryption is used during the broadcast preview. Then the content can be switched to the encrypted multicast mode. This method does not support on-demand preview. The on-demand preview is that whenever a subscriber is interested in viewing what is playing now, he is allowed to view the encrypted content for a pre-specified amount of time (e.g., 2 minutes) and the charge will start after that time with a warning (e.g., you will now be charged). The subscriber is authenticated the same way as if he is subscribing for the program and the bearer path set up is the same as if he is subscribing for the program. The difference is on the accounting and billing side. The Roundbox platform will pre-process the accounting records before feeding them into the backend billing systems/AAA server. The pre-processing will take into consideration that if the subscriber ends the program reception before the preview time slot expires, the accounting record is pre-processed so that the subscriber is not charged. Otherwise, the subscriber is charged according to the pricing plan. Another method for implementing the on-demand preview feature is to unicast the preview content on a separate stream (from the broadcast stream) once he presses the preview button. This method is simpler to implement but requires more network resources and may not scale to many subscribers.

9. Support of Over-The-Air Provisioning
Over the air provisioning is enabled so that if a subscriber wants to subscribe to a service, he can do so using his cell phone to download the client. This is done using J2ME or BREW programming. The subscriber is then able to start viewing the program immediately after he subscribes to the service. Here is an example set of steps:
   After a subscriber previews the programs, he presses yes on the menu to pay for the program.
   This brings up the subscription page with pricing options. For $x per month, unlimited viewing for certain channels. For $y, the subscriber can view this particular program (e.g., a baseball game) at the designated location.
Subscribers then chooses the desired option

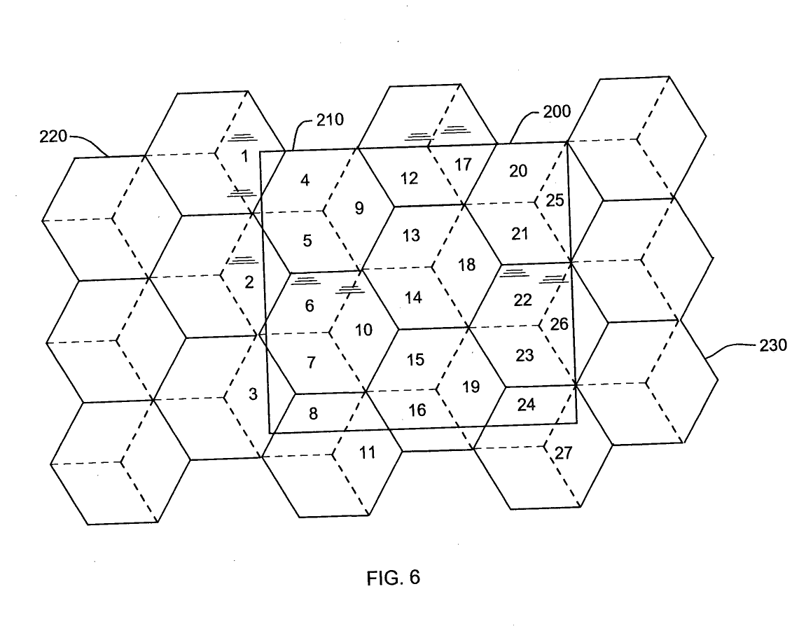

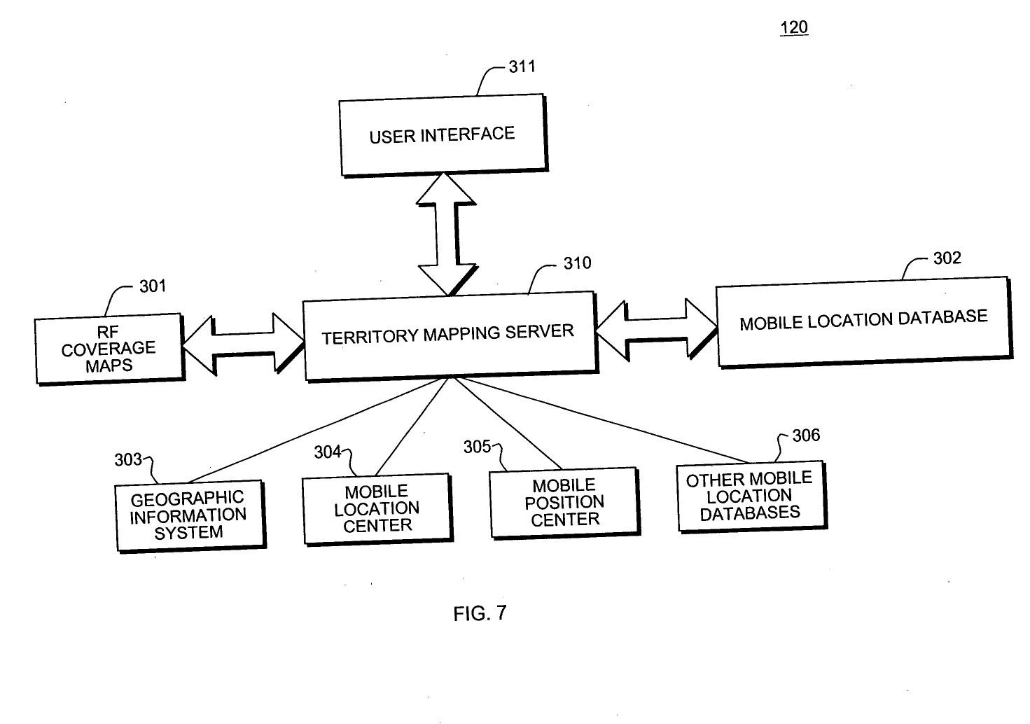

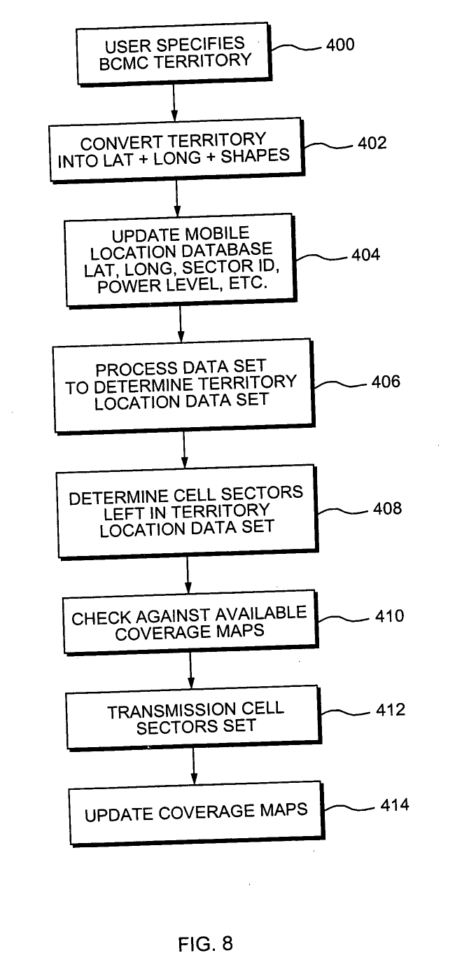

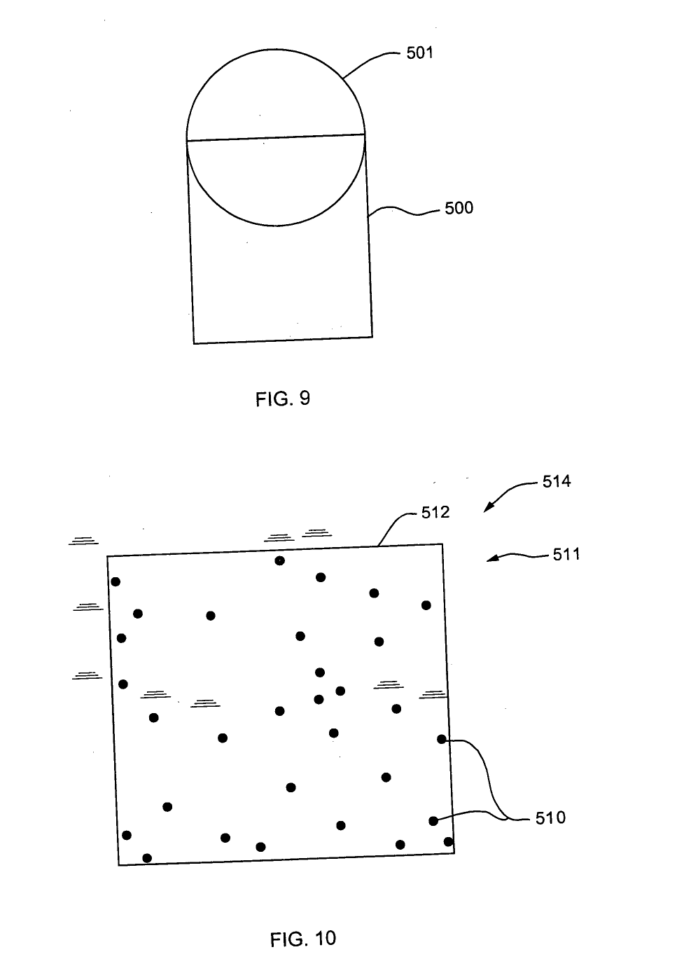

10. Broadcast/Multicast Territory Mapping
Of most importance to the present invention, as explained previously, emerging broadcast/multicast wireless technologies such as BCMCS and MBMS bear resemblance to that of TV/radio broadcasting in that it is now very efficient to scale the services to support many subscribers simultaneously, since many mobile devices may now share the same broadcast/multicast channel.
The Roundbox platform 120 introduces mechanisms for efficiently delivering targeted content. For each broadcast/multicast channel, there is the introduced notion of having a broadcast/multicast territory associated with it.
The broadcast/multicast territory can be defined in terms of a geographic area or in other ways. FIG. 2 shows that the broadcast/multicast territories can be as small as a street block. However, the territory can be as big as the whole nation.
For instance, The City of New York may need to broadcast certain channels (e.g., sports, news, event calendar) to a territory defined as Central Park in Manhattan.
For example, the City of New York might pay a mobile operator to broadcast these channels at Central Park. The mobile operator then needs to map Central Park to the corresponding cell sectors that perform radio signal transmission of broadcast/multicast content to cover Central Park. Radio signals transmitted from one or more base station sectors located in the vicinity of Central Park are thus needed to adequately cover the desired territory. With reference to FIG. 6, the Roundbox platform 120 supplies the necessary mechanisms to perform a mapping from broadcast/multicast territory 200 (Central Park in this case) to cell sectors 210 participating in transmitting the broadcast/multicast content.
The input to the mapping process is a geographic area. The geographic area 200 may be defined in many ways including: the popular name for a known location (e.g., Central Park), a street block, a stadium, an airport, a drawing on a map, a district, a city, a town, a state, a region, or the whole nation.
The output of the mapping process is a set of cell sectors that should transmit the broadcast/multicast signals to provide the coverage that most closely matches the desired geographic area. In the example shown in FIG. 6, the cell sectors participating should include cell sector numbers 1-27, with the un-numbered cell sectors 220, 230, etc. not participating.
FIG. 7 illustrates portions of the Rounbox platform that performs broadcast/multicast territory mapping. It consists of the following components:
RF Coverage Maps 301: Contains data representing the RF coverage area of each cell sector in a region.
Mobile Location Database 302: Used by the Territory Mapping Server to locally store derived or retrieved data indicating the location of mobile stations. Each data point should minimally have these parameters: latitude, longitude, timestamp, and cell sector ID.
Geographic Information System (GIS) 303: Contains a mapping between a geographic location/area (e.g. Central Park in Manhattan) and a defined position such as in terms of latitude and longitude.
Mobile Location Center(MLC) 304/Mobile Position Center(MPC) 305: These external databases contain Mobile Location data as made be provided by specific service environment (e.g., 3GPP2 or 3GPP). The data needed typically includes which indicates the location of mobile units in terms of the cell sector in which they are located and the latitude and longitude values.
Other Mobile Location Databases 306: In a mobile operator's networks, there might be databases that gather mobile location data for other purposes/applications.
Territory Mapping Server 310: This element is a key part, as it performs (a) mobile location data collection, from various network entities and pre-processes the location before depositing the data in the Mobile Location Database; and then (b) the mapping process, given the input and generates the mapping output, in a manner described below.
User Interface 311: An operator uses this interface to specify the input for the territory mapping and the interface displays the mapping output.
Note that these mobiles that provided the data points for territory mapping are not necessary the target broadcast/multicast subscribers. Data points can come from BREW APIs, GMLC, etc.
In the absence of available accurate RF coverage maps, the steps shown in FIG. 8 can be executed by the Territory Mapping Server 201 to perform territory mapping dynamically.
   1) First, an operator uses the User Interface to specify the broadcast/multicast territory (step 400). The operator can define it in latitude and longitude, in street blocks, or simply by drawing the territory on a GIS map.
   2) The Territory Mapping Server 301 then takes the input and uses the GIS 303 to convert the territory specification into latitude and longitude specification (step 402). The Territory Mapping Server 301 approximates the territory with the basic sets of shapes such as rectangle, circle, oval, triangle, etc. For example, Central Park can be represented by a rectangle of four end points defined in latitude and longitude. A territory can also be approximated by a combination of shapes. For instance, a territory might be represented by the joint area of a rectangle 500 and a circle 501 as shown in FIG. 9
   3) Next (step 404) the Territory Mapping Server (TMS) then gathers mobile location data and stores the data in the Mobile Location Database 302. This data can be accumulated over a period of time (e.g. the last week) from many mobiles. Note that these mobiles are not necessarily the mobiles that are receiving broadcast/multicast content. The mobile location data can come from the MLC 304 or MPC 305, or it can come from other proprietary databases 306 where mobile location data are stored. Alternatively, mobile location data can be obtained via the mobile client. The mobile client can initiate a mobile location query. Such a location query can be written in BREW or J2ME. The query is sent to the network location server. The server returns the location information to the mobile client. The client can then send the mobile location data to the TMS. In order to gather sufficient data points, all or even just some of the mobile clients can regularly query and obtain location data, and then send it the TMS. The data set should include the latitude and longitude of the mobile's location, a time stamp, the cell sector ID(s) and possibly power level. Mobile ID information can be left out of the location data information in order to protect the subscriber's identity and privacy. Note that there could be multiple Cell Sector IDs associated with a mobile due to a soft handoff mode condition, since when a mobile is in the soft handoff mode, it may be connecting with multiple cell sectors at the same time.
FIG. 10 is a graphic illustration of the information stored in the Mobile Location Database 302. The dots 510 represent the location of mobiles, the square 512 represents the broadcast/multicast territory (e.g., Central Park), and the triangle sections 514 are the base station sectors in which the mobiles are located.
   4) The TMS then processes the mobile location data set (step 406). In particular, the TMS filters the data set so the all data points fall within the broadcast/multicast territory 512 by comparing the latitude and longitude of the locations for each mobile with the shape definition(s) for the territory as previously defined (step 402). Further filtering can be used in order to make sure that the data is up to date. For example, one can add a time window to the filtering (e.g., only use last week's data). This step generates the Territory Location Data Set, which is a list of all mobiles in the territory.
   5) The Cell Sectors IDs associated with the mobiles left in the filtered Territory Location Data Set are the potential transmission cell sectors (step 408). Sometimes, this data set is not complete to include all the possible cell sectors needed to cover the broadcast/multicast territory. Sometimes, the data set contains cell sectors that overlap the same coverage area. It is safer to err on overlapping coverage rather than incomplete coverage.
   In this case, additional information can be used (step 410) to perform checks on the completeness. For instance, the mobile operator may have a database of its base stations (cells), their locations, and perhaps the RF coverage maps available. Many operators have such databases although it is not guaranteed that they are up to date. If such data is available, then use the broadcast/multicast territory defined in 402 as a filter to derive the base stations whose location fall within the broadcast/multicast territory. To be conservative, one could even add some more “room” to the defined broadcast/multicast territory by increasing the broadcast/multicast territory size definition in step 400.
This results in a Transmission Cell Sectors Set 412 that covers the broadcast/multicast territory most accurately.
   6) Over time, it is desirable and possible to map the broadcast/multicast territories more precisely. That is, as time for which each territory is active passes by, more user location data points are collected and filtered in the Territory Location Data Set. Based on the mobile location data and the power level data therein, it is then possible to devise a detailed map of the RF coverage area of a particular sector. This data can then be used to create the RF coverage map (step 414), from these observations of actual coverage. Note that the RF coverage maps of cell sectors can be dynamically and automatically updated. It alleviates the problem mentioned earlier of needing a team of people to maintain the data. There are other methods to obtain RF coverage maps. For instance, the RF coverage map of a cell sector can be measured and drawn out by using a RF test vehicle.
   7) Once the Radio Frequency (RF) coverage maps obtained, then one can perform the mapping in a relatively straight forward manner and obtain the Transmission Cell Sector Set. As mentioned above, FIG. 6 illustrates the concept of such mapping. Each hexagon 511 represents the RF coverage of a respective one of many three sectored base stations. (The sectors 514 are the diamond shapes within each hexagon 511.) The square 512 represents the broadcast/multicast territory (in this example, Central Park). Cell sectors 1 through 27 are needed to cover the Central Park territory represented by the square.
   8) Sometimes, such RF maps can be obtained from other means. However, they are usually not current or accurate. The RF coverage maps typically change with the season and sometimes with the radio network condition (e.g., a cell sector goes down). These maps could require a team of people to maintain in a mobile operator's network if not done automatically and dynamically.
   9) It is also desirable to dynamically and automatically adjust the mapping if a network event happens. Therefore, the system can also tie into the network management system if possible to detect material network changes that could impact the mapping. For example, if a cell sector 514 goes down, the system should find out automatically via network management system. Then the system will use the RF coverage map of each cell sector 514 and compensate as much as possible for the missing cell sector using adjacent cell sectors. In this instance, an updated program guide should be sent to these new cell sectors as well.

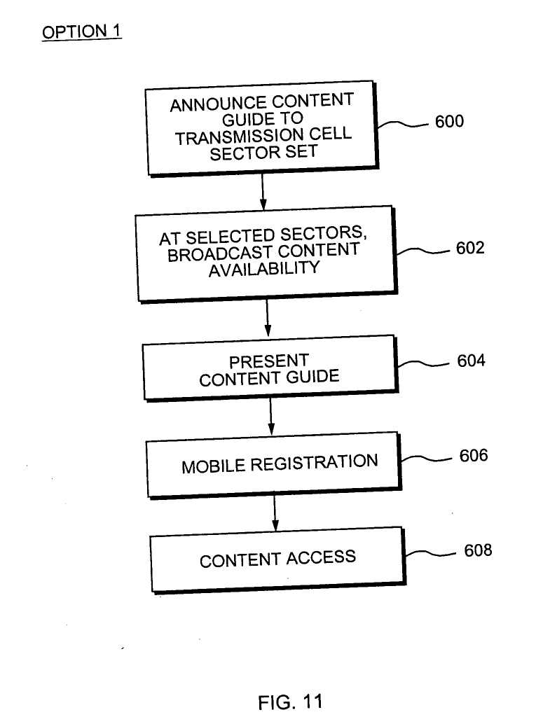

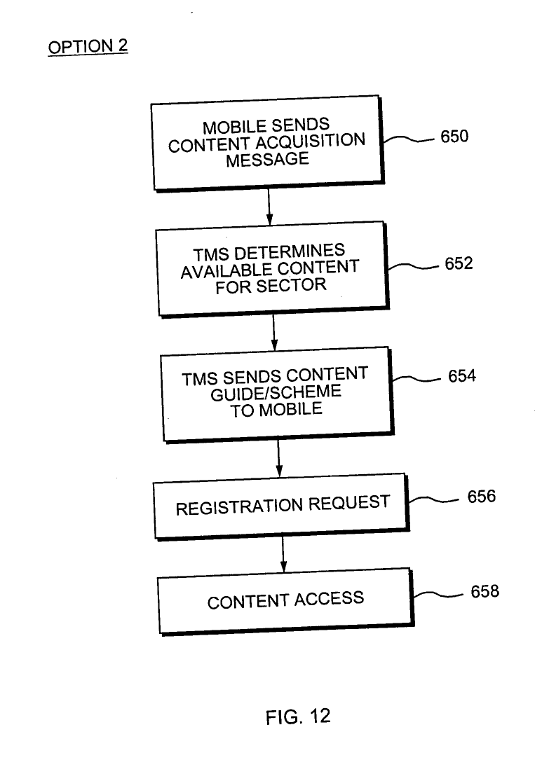

Once the Transmission Cell Sector Set is obtained in step 412, there are two options to implement the mapping. These are shown in the diagrams of FIGS. 11 and 12.

Option 1

1. A content/channel guide (similar to TV program guide) is announced to the cell sectors in the Transmission Cell Sector Set (step 600). The key here is that only those cell sectors within the Transmission Cell Sector Set will make the announcement, no more no less. There are several possible mechanisms to limit the distribution of the content guide: a) statically configure the distribution path via OA&M interfaces or b) if it needs to be dynamically configured, then the platform needs to send messages to the RAN to instruct the RAN to send the announcements to those cell sectors only.
2. Cell sectors in the Transmission Cell Sector Set then broadcast content/channel availability (step 602) to mobiles located in their sector. The mobile client 110 can then present the available content guide in many ways (step 604)—one possible way is that a subscriber selected a broadcast/multicast button or menu item that brings up a display of all available content/channels at his location. When the subscriber selects the content/channel by making a registration (step 606), the mobile then goes through the registration process. If registration is successful, he can start viewing the content (step 608).
   Option 2
1) The content/channel guide is not announced to the Transmission Cell Sectors in the Set. In this process, the mobile first send a generic information acquisition message to the Territory Mapping Server (step 650). Based on either the mobile's associated cell sector or location information, the TMS 310 then determines (step 652) that there are several types of content/channels available to the subscriber at that particular location. It sends all the necessary program information to the mobile (step 654).
2) The subscriber makes a registration request (step 656) for such content/channel. If the subscriber passes registration, then he can start accessing the content (step 658).

1.2.2.2 Content Management 163
Returning now attention to FIG. 2, the Content Management function of the Roundbox platform 130 will be described in greater detail.

1. Link Management for Content Transport
The content source may reside in a content provider's network. Some content could be a live feed. A secure connection is established and maintained between the mobile operator's core network and the content provider's network.

2. Interface for Each Content Provider to Manage Its Content
In some business models, a content provider buys a channel from the mobile operator and manages the content himself. In this case, an interface is provided to the content provider for it to schedule, announce, monitor and terminate its programming.

3. Location-Based Content Management
From a subscriber's perspective, when he moves from one location to another, he may be receiving different content. Each cell sector represents the minimal unit of a broadcast/multicast territory. Content within the broadcast/multicast channels could vary from cell sector to cell sector. A particular cell sector's coverage area is mapped to a geographic location (Central Park of Manhattan). The Roundbox platform manages various location-dependent content.

1.2.2.3 Subscriber Management 163

Subscriber Management is responsible for processing data related to subscribers and subscriber groups. It is responsible for accessing and updating subscriber profile data. It presents a unified front end for subscriber data management to the other functions of the platform. It also maintains the subscriber group lists for various broadcast/multicast services. For instance, for the emergency notification application, the subscriber group could be the first responders defined by certain government entities. Subscriber data utilizes a common XML-based data model. It processes the subscriber data from multiple sources and converts data formats from distributed data stores into the common XML data structure. It supports database procedures: create, delete, modify, query, subscribe, unsubscribe and notify as described by the Generic User Profile standard of 3GPP. The data management among the distributed network entities is done via web services.

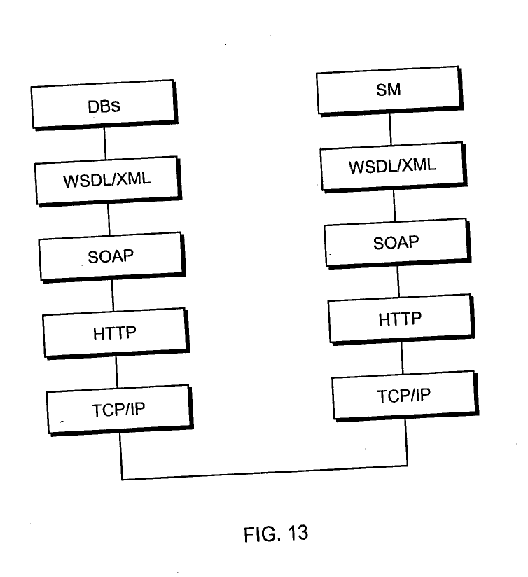

FIG. 13 is an example of a web services interface between Subscriber Management and distributed databases. Additionally, the subscriber presence information can be retrieved from the presence database to the subscriber data set to enhance the delivery of broadcast/multicast content. Both static and dynamic subscriber groups are supported. Static subscriber groups are the subscribers who have subscribed to certain groups (e.g., monthly subscription). Dynamic groups are the subscribers who are actively participating in a particular program/session (e.g., an interactive game or a conference call).

1.2.2.4 Traffic Management
A Radio Access Network (RAN) manages local traffic on a per sector basis in order to optimize spectrum efficiency over the air. Radio management is typically performed at function called the Radio Network Controller (RNC). The RNC manages the radio resources of all the cell sectors underneath it. Traffic Management performed by the Roundbox platform 120 is done at the system level and is thus complimentary to the radio management performed by the RAN. The Roundbox platform 120 has the overall broadcast/multicast system view by collecting the following network information: network topology, subscriber distribution (the number of subscribers in each cell sector), the number of channels (data rates, QoS) in each cell sector. In addition, the Roundbox platform 120 maintains all the policies set by the mobile operators based on their constraints and various business needs. The business considerations are also key to making optimal decisions on traffic management.

1.2.2.4.1 Admission Control and Congest Control
Normally there should be enough network resources to support all the scheduled programs. Since broadcast/multicast traffic often shares the same bandwidth with the unicast traffic, it is possible that during the actual broadcast/multicast period, unicast traffic is taking more bandwidth than anticipated, thus not leaving enough bandwidth for broadcast/multicast programs scheduled earlier. To alleviate the problem, the Roundbox platform supports the configuration of statically allocating a fixed bandwidth for broadcast/multicast. It schedules enough program channels to fully utilize the allocated bandwidth on a sector without overloading it. The platform also supports broadcasting/multicasting in the background using the idle cycles of the remaining bandwidth set aside for unicast. In this case, real-time cell sector utilization information is needed. If this information can not be obtained from RNC, then another possibility is to use the mobile clients on mobile devices to collect real-time throughput and QoS information for each channel. Based on the aggregate QoS information, network condition/utilization can be inferred. If the aggregate QoS perception is good, then new programs may be admitted on the air.
Admission control is used to decide whether a new channel can be established taking into these considerations: network utilization, service agreements, revenue opportunities, etc. Broadcast/multicast branches are added on-demand as shown in FIG. 11. If there are subscribers under a cell sector, then there is a tree branch to the sector. When there is no one in the cell sector, then the branch is removed.
Good admission control minimizes congestion, but does not eliminate congestion. RAN performs local congestion control. In order to optimize application delivery, higher level congestion control is also needed. For instance, in some existing video delivery systems, an end-to-end congestion control mechanism is utilized in addition to the RAN level congestion control. Sometimes the broadcast/multicast territories overlap in some sectors, which could result in congestion. In this case, the Roundbox platform keeps track of the number channels to each cell sector and the data rate of each channel. In order to prevent congestion, the controller could shed traffic in several areas: data rates, the number of channels being broadcast/multicast in a given time interval, whether or not a new channel can be established. Since the platform has the overall system view as well as the business logic/policy, it is in a good position to manage congestion for broadcast/multicast traffic. The platform intelligently sheds broadcast/multicast channels when congestion happens. Congestion event can be notified by the RNC. If RNC does not provide such information, then mobile client can collect throughput and QoS information. Congestion within a particular cell sector can be detected by monitoring real-time aggregate user feedback from that cell sector. In this case, broadcast/multicast traffic to this particular cell sector can be shedded. The decision on what traffic should be dropped depends on several factors: data rate and QoS of the channel, revenue of the channel, popularity of the channel, service agreement with content providers, etc.

1.2.2.4.2 Traffic Optimization
Even though RNC performs radio resource optimization for all cell sectors below it, it does not necessarily optimize at the network level. FIG. 12 illustrates how the Roundbox platform can help optimize radio resources required for broadcast/multicast traffic. The subscribers are distributed in the seven cell sectors below, therefore 7 channels are established to cover these subscribers. However, if a macro cell (in blue) is available, it might be more efficient to switch all the subscribers to the macro cell. In this case, 3 channels are needed.

1.2.2.4.3 Handoff Management

The RAN makes local handoff decisions on when and how to perform handoff for each channel or subscriber. But handoff decisions should also be made based on business requirements as well. Depending the service level agreement with the content provider, there might be different handoff policies. For instance, the flight schedule is broadcast free to subscribers at Newark Airport. If the subscriber leaves the broadcast territory, then the content is no longer available to the subscriber according to the SLA between Newark Airport and Verizon Wireless. However, for venue cast of game radio at the Yankee Stadium, if the subscriber leaves early, is his game radio session allowed to follow him? It is a business decision and the mobile operator sets the policy on a per program and/or per subscriber basis. If the subscriber is a flat-rate monthly subscription customer, then perhaps the mobile operator may not allow handoff once he is out of a pre-defined territory. The mobile operator may allow for the handoff if the subscriber is a pay per view subscriber (e.g., he paid $5 for the game radio.)

FIG. 13 and FIG. 14 illustrate the impact of handoff on the network. At the beginning of the game, there is one broadcast/multicast channel to the stadium and 1000 subscribers tune into the channel. Towards the end of the game, more broadcast/multicast channels are established to follow the subscribers as they leave the stadium. Management of the handoff traffic is essential in preventing congestion while allowing mobile operators to optimize revenue and support their service agreements with content providers, enterprise customers and subscribers.

1.2.3 Business Analytics
A business analytics function collects the usage statistics and generates reports for mobile operators. Traffic analysis reports by channel, application, location, event, time and subscribers will be generated. Revenue and cost analysis reports will also be generated. For instance, revenue/megabit can be used as a normalized measure for the revenue brought in by an application in relationship to the bandwidth required. The statistics give mobile operators a better picture on the broadcast/multicast services: the utilization, user distribution, and revenue distribution of a specific program/application. It helps a mobile operator to fine tune the existing pricing model and experiment with new business models. For instance, what is the optimal charge for the pay per view subscriber at a specific venue? Mobile operator can experiment with the pricing and use the reports to find an optimal pricing point for the pay per view charge.

1.3 Mobile Client 110
The Roundbox mobile client 110 can be written in a suitable mobile application language such as J2ME and BREW. It preferably supports several features:

1. TiVo-Like Feature
A subscriber pre selects the channels/content that he wants to record.
Broadcast/multicast content is stored on the handset as long as the handset is powered on.
Subscriber can rewind, view and fast forward the content at a later time.

2. Program Preview
Subscriber can preview certain channels before paying for the content.

3. Interaction Management
To support the mobile transaction portal capability on the platform, the mobile client provides the interfaces for a subscriber to move an arrow to click on some interactive links to initiate certain mobile transactions. The interactive links could be a telephone number or a URL.
The mobile client then sends out these requests to the platform that knows how to handle these requests according to the business rules.
Mobile client and the platform server share a set of pre-defined messages on how to handle various types of transactions.

4. SIP Client
Mobile client uses the SIP client to initiate telephones calls. The SIP client is typically embedded in the handsets.

5. Global Positioning System (GPS) Support
Mobile client will generate location queries (e.g., by using BREW and J2ME APIs) to the network location servers. The network location server will return the mobile location information to the mobile client. The mobile client will then send the location information to the Territory Mapping Server. The TMS can use the subscriber location information to perform territory mapping as discussed in the Territory Mapping Section of this patent.

6. End User Quality Measurements
The existing broadcast/multicast technologies such as MBMS and BCMCS do not have an uplink feedback loop on the reception of the broadcast/multicast signals. Therefore the network does not know what kind of QoS a subscriber is receiving on a particular channel. This could be a problem when it comes to charging. A subscriber may complain about not receiving the content that he just paid $5 for. The mobile client measures the data rate that is received by the device and the error rate of the content. The mobile client then reports the measurements to the platform. The measurement units include the following fields: channel ID, flow ID, Cell ID (Cell Sector ID), data rate received, error rate, GPS (occasionally). Such measurements are also very useful for traffic management as described in the Traffic Management section of this document.

1.4 Applications 170

The platform (FIG. 2) also supports a wide variety of one-to-many and many-to-many broadcast/multicast services/applications. The services/applications include local broadcasting with location specific content (e.g., weather, traffic, event calendar), venue multicasting of a sports event, emergency event notification, interactive TV/radio, push-to-talk, conference calls, and multi-person mobile games.

The services are designed not to be intrusive.

As an example service, consider the display of available content or the program guide mentioned above. When a subscriber clicks on the broadcast/multicast icon on his handset, the following channel description is displayed on the screen.

| | Preview all channels |
|---|---|
| Channel | Content |
| 1 | News |
| 2 | Movie |
| 3 | Sports |
| 4 | Flight Schedule |
| 5 | Weather |

If he clicks on “Preview all channels”, he can surf through all the channels that are playing. If he is not a subscriber, he can preview for certain amount of time without paying.

If he clicks on channel 3, he receives a program guide for the channel as shown in the following table.

| Time | Content |
|---|---|
| 1 PM | Sports Summary |
| 2 PM | US Open men's Single Semi- |
| | final |
| 5 PM | Sports Summary |
| 7 PM | Football |

If he clicks on 2 PM, he receives a description of the US Open semi-final and its players' background.

At that time, the subscriber is prompted whether he wants to pay for this program on a pay per view basis if he is not a subscriber to it already or if he wants to subscribe to a monthly service. If the subscriber chooses the first option, then the broadcast/multicast territory and the pay-per-view pricing information are shown. If the subscriber says yes to it, then the subscriber is prompted whether he wants to record the game and that he has x number of minutes of storage time on his phone. If the subscriber says yes, he may be informed: FYI, there are x minutes of recording time left on your phone.

At 2 PM, the subscriber goes to Channel 3 to watch the US Open while the content is being recorded. He can modify the recording time. At the end of the match, the subscriber is prompted “Your subscription has ended. Press P to go back to program guide.”

### REFERENCES

The following wireless standards documentation are available from the “3rd Generation Partnership Project (3GPP)”, an international organization with Organizational Partners including ARIB, CCSA, ETSI, ATIS, TTA, and TTC. The following documentation is hereby incorporated by reference in this document as if fully contained herein.
[1] 3GPP2 S.R0030-A Version 1.0, January 2004, Broadcast/Multicast Services—Stage 1 Revision A.
[2] 3GPP2 C.S0054-0 Version 1.0, February 2004, CDMA2000 High Rate Broadcast-Multicast Packet Data Air Interface Specification.
[3] 3GPP2 S.R0083-0 Version 1.0, October 2003, Broadcast-Multicast Service Security Framework.
[4] 3GPP2 X.P0019, March, 2003, Broadcast and Multicast Service Framework.
[5] 3GPP2 X.P0022, October, 2003, Broadcast and Multicast Service in cdma2000 Wireless IP Network.
[6] 3GPP A.S0019, March 2004, Interoperability Specification (IOS) for Broadcast Multicast Services (BCMCS).
[7] 3GPP TS 22.146, Multimedia Broadcast/Multicast Service; Stage 1.
[8] 3GPP TS 22.246, MBMS User Services.
[9] 3GPP TS 23.246, Multimedia Broadcast/Multicast Service (MBMS); Architecture and Functional Description.
[10] 3GPP TR 23.846, Multimedia Broadcast/Multicast Service (MBMS); Architecture and Functional Description.
[11] 3GPP TR 25.992, Multimedia Broadcast Multicast Service (MBMS); UTRAN/GERAN Requirements.
[12] 3GPP TR 25.803 S-CCPCH Performance for MBMS

1. A method for providing a content delivery service to subscribers in a wireless network comprising the steps of:
receiving a description of a desired broadcast/multicast (BCMC) territory in terms of an extent of a physical area;
receiving a content indicator associated with the BCMC territory, such content indicator to be supplied to subscribers located in the BCMC territory;
estimating cell sector coverage areas for one or more cell sectors;
identifying a set of targeted cell sectors, by using the BCMC territory description and the estimated cell sector coverage areas to identify the set of targeted cell sectors as those sectors that relate to the BCMC territory; and
sending the content indicator to the set of targeted cell sectors using a BCMC protocol.

2. A method as in claim 1 wherein the broadcast/multicast territory is selected from a group consisting of a predetermined area defined by latitude/longitude points.

3. A method as in claim 1 wherein the broadcast/multicast territory is defined in terms of a venue selected from exemplary named venues such as an airport, stadium, freeway location, or other public named place designation.

4. A method as in claim 3 wherein the content indicator is associated with the named venue and is selected from exemplary content indicators such as flight schedules, sport event statistics, freeway traffic reports, or other venue-associated content.

5. A method as in claim 1 wherein the content indicator is a program guide indicating one or more of a content stream, a channel, time, or availability.

6. A method as in claim 1 additionally comprising the step of:
determining when events occur that result in changes to the cell sector coverage areas.

7. A method as in claim 6 wherein the events include at least the detection of a malfunctioning cell sector.

8. A method as in claim 1 wherein the step of estimating cell sector coverage areas further comprises:
determining a subscriber location data set that includes at least a geographic location and a cell sector identifier for multiple subscribers.

9. A method as in claim 8 wherein the step of identifying a set of targeted cell sectors further comprises:
filtering the subscriber location data set.

10. A method as in claim 1 wherein the step of estimating cell sector coverage areas further comprises:
accessing one or more radio frequency cell sector coverage maps.

11. A method as in claim 8 wherein the cell sector coverage areas are provided by historical observations of the subscriber location data set.

12. A method as in claim 8 wherein the step of identifying a set of targeted cell sectors further comprises determining a Territory Location Data Set consisting of a filtered subscriber location data set.

13. A method as in claim 12 wherein the step of identifying a set of targeted cell sectors further comprises determining a Transmission Cell Sectors Set as the cell sectors that are associated with the subscribers in the Territory Location Data Set.

14. An apparatus for delivering content to subscribers in a wireless network comprising:
a user interface for receiving a description of a desired broadcast/multicast (BCMC) territory in terms of an extent of a physical area, and for receiving a content indicator associated with the BCMC territory, such content indicator to be supplied to subscribers located in the BCMC territory;
a mapping server, for identifying a set of targeted cell sectors, by using the BCMC territory description and the estimated cell sector coverage areas; and
a content transmitter, for sending the content indicator to the set of targeted cell sectors using a BCMC protocol.

15. An apparatus as in claim 14 wherein the broadcast/multicast territory is selected from a group consisting of a predetermined area defined by latitude/longitude points.

16. An apparatus as in claim 14 wherein the broadcast/multicast territory is defined in terms of a venue selected from exemplary named venues such as an airport, stadium, freeway location, or other public named place designation.

17. An apparatus as in claim 16 wherein the content indicator is associated with the named venue and is selected from exemplary content indicators such as flight schedules, sport event statistics, freeway traffic reports, or other venue-associated content.

18. An apparatus as in claim 14 wherein the content indicator is a program guide indicating one or more of a content stream, a channel, time, or availability.

19. An apparatus as in claim 14 wherein the mapping server additionally determines when events occur that result in changes to the cell sector coverage areas.

20. An apparatus as in claim 19 wherein the events include at least the detection of a malfunctioning cell sector.

21. An apparatus as in claim 14 wherein estimated cell sector coverage areas are provided from a subscriber location data set that includes at least a geographic location and a cell sector identifier for multiple subscribers.

22. An apparatus as in claim 21 wherein the the set of targeted cell sectors are determined by filtering the subscriber location data set.

23. An apparatus as in claim 14 wherein the estimated cell sector coverage areas are provided from one or more radio frequency cell sector coverage maps.

24. An apparatus as in claim 21 wherein the estimated cell sector coverage areas are provided by historical observations of the subscriber location data set.

25. An apparatus as in claim 21 wherein the set of targeted cell sectors further comprises a Territory Location Data Set consisting of the filtered subscriber location data set.

26. An apparatus as in claim 25 wherein the set of targeted cell sectors further comprises a Transmission Cell Sectors Set comprising the cell sectors that are associated with the subscribers in the Territory Location Data Set.
